(19) United States
(12) Patent Application Publication
(10) Pub. No.: US 2008/0048377 A1
(43) Pub. Date: Feb. 28, 2008

(54) POSITIONING APPARATUS

(75) Inventors: FU-SHUN HUANG, Tu-Cheng (TW); YI-HUA LIU, Shenzhen (CN); SHU-WEI ZHOU, Shenzhen (CN); JIAN LUO, Shenzhen (CN); YUN-FENG ZHANG, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/615,013

(22) Filed: Dec. 22, 2006

(30) Foreign Application Priority Data
Aug. 25, 2006 (CN) 200610062300.8

(51) Int. Cl. B23Q 3/00

(52) U.S. Cl. 269/305

(57) ABSTRACT

A positioning apparatus (10), mounted on a machine tool (60), for positioning a workpiece (30) on the machine tool, comprises a positioning member (12), at least one sliding element (14), and at least one positioning element (18). The positioning member comprises a first portion (120) comprising a recessed portion (122) and at least one receiving hole (128). The sliding element slidably received in the recessed portion, the sliding element comprising a first engaging portion (142). The positioning element comprises a second engaging portion (182) and a positioning portion (186) connected to the second engaging portion. The second engaging portion extends through the receiving hole and is engaged with the first engaging portion.

### BACKGROUND OF THE INVENTION

1. Field of the Invention

The present invention pertains to a positioning apparatus, and particularly to a positioning apparatus capable of positioning a variety of workpieces.

2. Description of Related Art

Positioning apparatuses are commonly used for positioning a workpiece on a machine tool. Conventionally, the positioning apparatuses are designed to work with one workpiece of a specific size and shape, thus the positioning apparatuses cannot be used for positioning any other workpiece that is not of the same size and shape. It is expensive to build a positioning apparatus for each different workpiece design.

Therefore, a heretofore unaddressed need exists in the industry to overcome the aforementioned deficiencies and inadequacies.

### SUMMARY OF THE INVENTION

In an exemplary embodiment, a positioning apparatus, mounted on a machine tool, for positioning a workpiece on the machine tool, comprises a positioning member, at least one sliding element, and at least one positioning element. The positioning member comprises a first portion comprising a recessed portion and at least one receiving hole. The sliding element slidably received in the recessed portion, the sliding element comprising a first engaging portion. The positioning element comprises a second engaging portion and a positioning portion connected to the second engaging portion. The second engaging portion extends through the receiving hole and is engaged with the first engaging portion.

Other advantages and novel features will become more apparent from the following detailed description of preferred embodiments when taken in conjunction with the accompanying drawings, in which:

### BRIEF DESCRIPTION OF THE DRAWINGS

FIG. 1 is an exploded, isometric view of a positioning apparatus of an exemplary embodiment of the present invention;

FIG. 2 is a partly assembled view of the positioning apparatus of FIG. 1;

FIG. 3 is an assembled view of the positioning apparatus of FIG. 1;

FIG. 4 is an isometric view, showing the positioning apparatus of FIG. 3 positioning a workpiece on a machine tool.

### DETAILED DESCRIPTION OF THE INVENTION

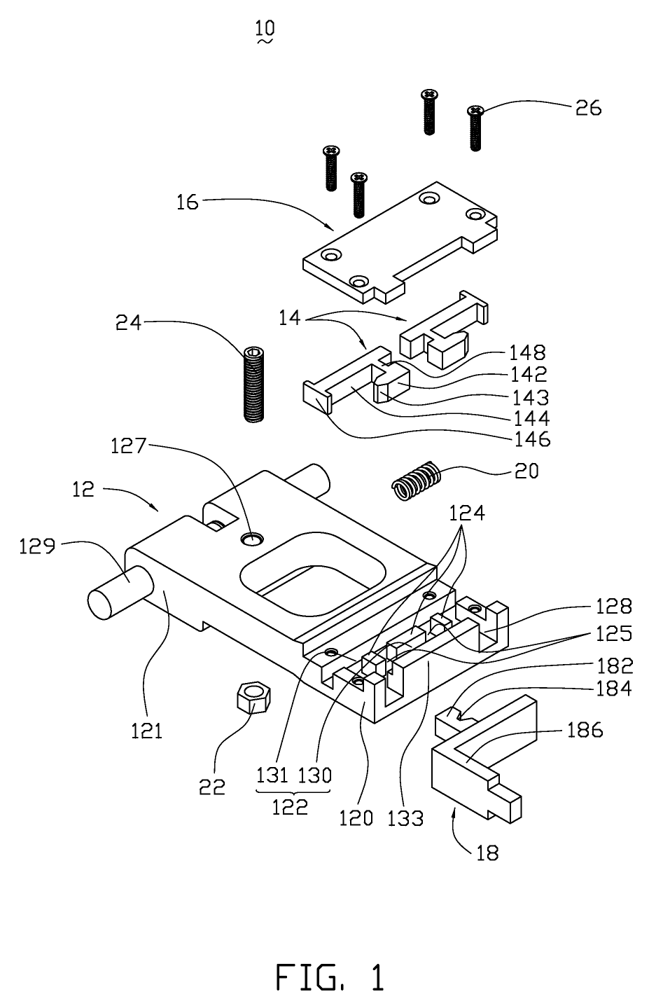

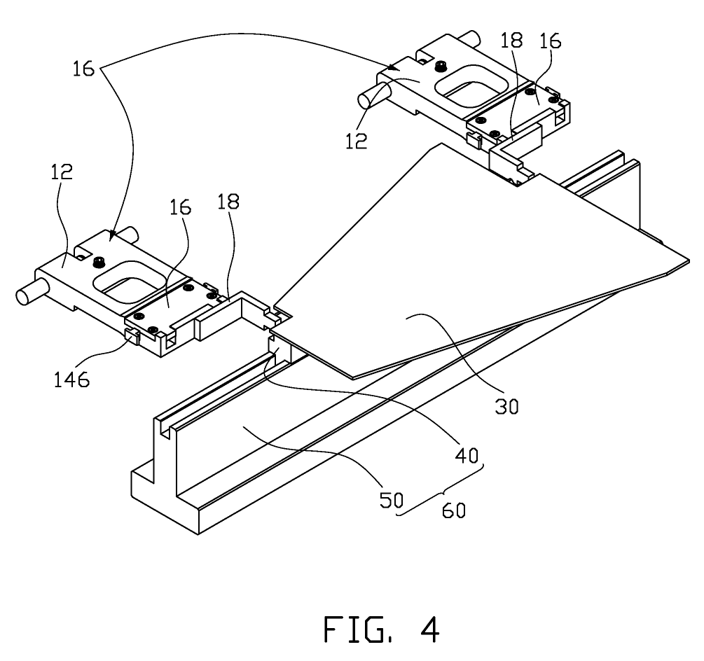

Referring to FIGS. 1 and 4, a positioning apparatus 10 of an exemplary embodiment of the present invention is mounted on a machine tool 60 for positioning a workpiece 30 on the machine tool 60. The positioning apparatus 10 comprises a positioning member 12, a pair of sliding elements 14, a positioning element 18, and a cover 16. The machine tool 60 comprises a lower die set 50 and a lower die 40 mounted on the lower die set 50. The workpiece 30 is mounted on the lower die 40. In an alternative embodiment, the number of the positioning element 18 may be two.

The positioning member 12, the sliding elements 14, and the cover 16 cooperatively form a fixing apparatus for fixing the positioning element 18 on the machine tool 60.

Each sliding element 14 comprises a sliding body 144, a first engaging portion 142, a retaining portion 146, a connecting portion 148, and a head 143. The retaining portion 146 is disposed on one end of the sliding body 144. The connecting portion 148 is disposed adjacent to another end of the sliding body 144. The first engaging portion 142 is located at a distal end of the connecting portion 148 and is parallel to the sliding body 144. The head 143 is tapered and is disposed at a distal end of the engaging portion 142.

The positioning member 12 comprises a first portion 120 and a second portion 121 opposite to the first portion 120. The first portion 120 comprises a recessed portion 122, a front wall 133, and a pair of receiving holes 128. The front wall 133 is located on an end of the first portion 120. A width of the recessed portion 122 is substantially equal to that of the sliding element 14. The recessed portion 122 comprises a first groove 130, a second groove 131, and three blocks 124. The blocks 124 are used for limiting distance of movement of the sliding element 14, and separate the first groove 130 and the second groove 131. The blocks 124 are arranged in a line, and every two adjacent blocks 124 cooperatively define a slot 125 therebetween. The receiving holes 128 are disposed adjacent to opposite sidewalls of the first portion 120, and extend horizontally from the front wall 133 to the second groove 131. The second portion 121 comprises a shaft 129 mounted to the machine tool 60. The positioning member 12 further comprises a threaded-hole 127 extending through the positioning member 12. The threaded-hole 127 is defined adjacent to the second portion 121.

The positioning element 18 comprises a second engaging portion 182, a positioning portion 186, and a notch 184 for receiving the head 143. The second engaging portion 182 is perpendicularly connected to the positioning portion 186. The notch 184 is disposed on the second engaging portion 182. The second engaging portion 182 is received in the receiving hole 128 and is engaged with the first engaging portion 142. In the exemplary embodiment, the positioning portion 186 is L-shaped.

The positioning apparatus 10 further comprises a resilient member 20, a set screw 24, a nut 22, and a plurality of screws 26. The resilient member 20 is received in the first groove 130. The set screw 24 is received in the threaded-hole 127. The nut 22 is mounted to an end of the set screw 24. The set screw 24, the threaded-hole 127, and the nut 22 cooperatively form an adjusting member for adjusting a position of the positioning member 12, thus exactly positioning the positioning apparatus 10 on the machine tool 60. In the exemplary embodiment, the resilient member 20 is a coil spring.

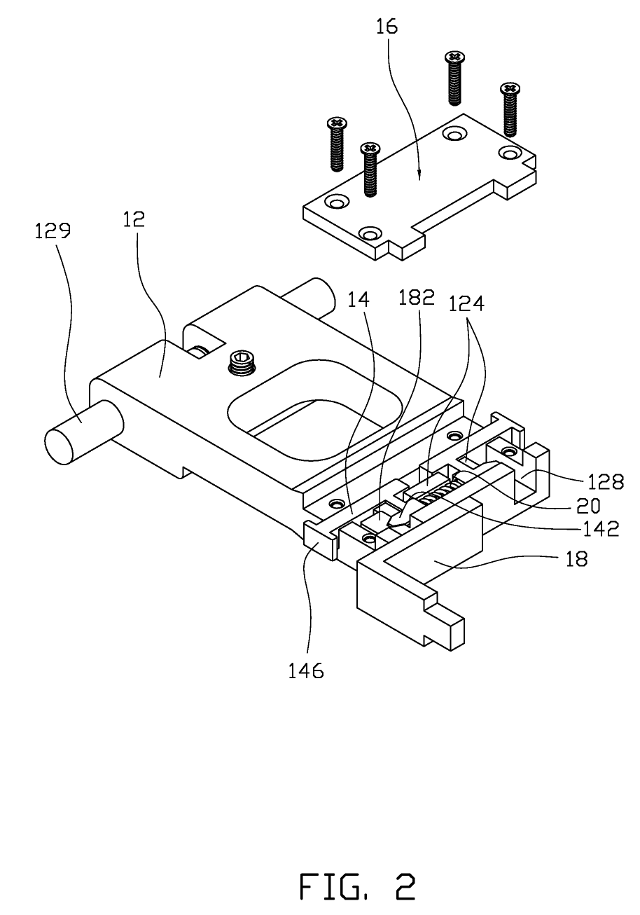

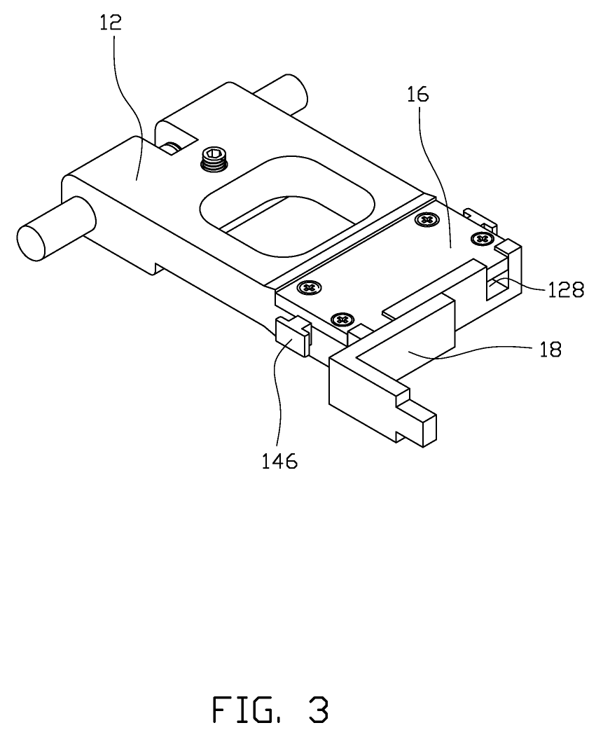

Referring also to FIGS. 2 and 3, in assembly, each sliding element 14 is slidably received in the recessed portion 122. The connecting portion 148 of each sliding element 14 is received in the corresponding slot 125. The first engaging portion 142 is received in the first groove 130. The sliding body 144 is received in the second groove 131. The retaining portions 146 of the sliding elements 14 are separately located adjacent to opposite sides of the positioning member 12. The resilient member 20 is received in the first groove 131, and located between the pair of first engaging portions 142. The cover 16 is mounted to the positioning member 12 by the screws 26 for covering the recessed portion 122, thus preventing dust from entering into the recessed portion 122. The set screw 24 is received in the threaded-hole 127. The nut 22 is mounted to the end of the set screw 24. The second engaging portion 182 of the positioning element 18 passes through a selective one of the receiving holes 128 and is engaged with the first engaging portion 142 of the corresponding one of the sliding elements 14. The head 143 of the sliding element 14 is received in the notch 184 of the positioning element 18.

Referring also to FIG. 4, during use, each retaining portion 146 of the corresponding sliding element 14 is pushed toward a center of the positioning member 12 by an external force to compress the resilient member 20. Thereby each first engaging portion 142 of the corresponding sliding element 14 moves away from the corresponding receiving hole 128. And thus, the second engaging portion 182 of the positioning element 18 is easily inserted into a selective one of the receiving holes 128. The resilient member 20 is decompressed when the external force is removed, thus driving each first engaging portion 142 of the corresponding sliding element 14 to move away from the center of the positioning member 12, thus engaging the first engaging portion 142 with the second engaging portion 182. The head 143 of the sliding element 14 is received in the corresponding notch 184. Therefore, the positioning element 18 is stably mounted to the machine tool 60. The positioning portion 186 of the positioning element 18 abuts against the workpiece 30 so as to position the workpiece 30 on the lower die 40.

The positioning portions 186 of the positioning elements 18 may be designed to position a variety of workpieces 30 each of different size and shape. Thus, during use, an appropriate positioning element 18 is selected for positioning the current workpiece 30. And thus, the positioning apparatus 10 is easily adjusted to position various workpieces 30.

In addition, it is convenient to disengage and engage the first engaging portion 142 from the second engaging portion 182 to remove the positioning element 18 and exchange it for another.

Furthermore, with the positioning member 12 having a pair of receiving holes 128 for receiving a pair of positioning elements 18 therein, the positioning apparatus 10 can position a pair of workpieces 30 at the same time. Besides, the pair of positioning elements 18 can also be different from each other so as to be automatically adjustable to position workpieces of variable sizes and curvatures.

While exemplary embodiments have been described above, it should be understood that they have been presented by way of example only and not by way of limitation. Thus the breadth and scope of the present invention should not be limited by the above-described exemplary embodiments, but should be defined only in accordance with the following claims and their equivalents.

1. A positioning apparatus, mounted on a machine tool, for positioning a workpiece on the machine tool, comprising:
a positioning member comprising a first portion comprising a recessed portion and at least one receiving hole, the recessd portion comprising a first groove, a second groove, and three blocks separating the first groove and the second groove and arranged in a line, every two adjacent blocks defining a slot therebetween;
at least one sliding element slidably received in the recessed portion, the at least one sliding element comprising a first engaging portion; and
at least one positioning element comprising a second engaging portion and a positioning portion connected to the second engaging portion, the second engaging portion passing through the at least one receiving hole and being engaged with the first engaging portion.

2. The positioning apparatus as claimed in claim 1, wherein the at least one sliding element comprises a pair of sliding elements.

3. The positioning apparatus as claimed in claim 2, further comprising a resilient member disposed between the pair of sliding elements.

4. The positioning apparatus as claimed in claim 3, wherein the resilient member is a coil spring.

5. The positioning apparatus as claimed in claim 1, wherein the first portion further comprises a front wall; the at least one receiving hole extends through the front wall.

6. The positioning apparatus as claimed in claim 1, further comprising a cover mounted to the positioning member for covering the recessed portion.

7. The positioning apparatus as claimed in claim 1, wherein the positioning member further comprises a second portion opposite to the first portion, the second portion comprising a shaft for being mounted to the machine tool.

8. The positioning apparatus as claimed in claim 1, further comprising an adjusting member for adjusting a position of the positioning member.

9. The positioning apparatus as claimed in claim 8, wherein the adjusting member comprises a threaded-hole extending through the positioning member, a set screw received in the threaded-hole, and a nut mounted to an end of the set screw.

10-11. (canceled)

12. The positioning apparatus as claimed in claim 1, wherein the at least one sliding element further comprises a sliding body, a retaining portion disposed on one end of the sliding body, and a connecting portion disposed on another end of the sliding body and connecting to the first engaging portion, the connecting portion being received in one of the slots, the first engaging portion being receiving in the first groove, and the sliding body being received in the second groove.

13. The positioning apparatus as claimed in claim 1, wherein the at least one sliding element further comprises a head disposed on a distal end of the first engaging portion.

14. The positioning apparatus as claimed in claim 13, wherein the positioning element further comprises a notch for receiving the head.

15. An assembly for machining workpieces, comprising:
a machine tool; and
a positioning apparatus disposed beside said machine tool for positioning a workpiece to be machined around said machine tool, said positioning apparatus comprising a positioning member disposed beside said machine tool, and a positioning element separately formed from said positioning member, said positioning element removably connectable with said positioning member so as to be placed between said positioning member and said workpiece to reachably position said workpiece around said machine tool.

16. The assembly as claimed in claim 15, further comprising a sliding element disposed in said positioning member, said sliding element movable to engage with said positioning element for securing said positioning element to said positioning member in a first position of said sliding element, and movable to disengage from said positioning element to release said positioning element for removing from said positioning member in a second position of said sliding element.

17-18. (canceled)

19. The assembly as claimed in claim 16, wherein said at least one sliding element further comprises a sliding body, a retaining portion disposed on one end of said sliding body, and a connecting portion disposed on another end of said sliding body and connecting to said first engaging portion, said connecting portion being received in one of said slots, said first engaging portion being received in said first groove, and said sliding body being received in said second groove.

20. An assembly for machining workpieces, comprising:
a machine tool; and
a positioning apparatus disposed beside said machine tool for positioning a workpiece to be machined around said machine tool, said positioning apparatus comprising a positioning member disposed beside said machine tool, a sliding element and a positioning element separately formed from said positioning member, said positioning element removably connectable with said positioning member so as to be placed between said positioning member and said workpiece to reachably position said workpiece around said machine tool, said positioning member comprising a recessed portion, said recessed portion comprising a first groove, a second groove, and at least two blocks separating said first groove and said second groove and arranged in a line, every two adjacent blocks defining a slot therebetween, said sliding element movably receivable in said recessed portion and extending in said first and second grooves respectively through said slot, said sliding element movable in said first and second grooves and movably engagable with said positioning element in said first groove so as to connect said positioning element with said positioning member.

21. (canceled)

22. The positioning apparatus as claimed in claim 12, wherein the at least one sliding element is movable to a first position in which the at least one sliding element is engaged with the positioning element thereby securing the positioning element to the positioning member, and is movable to a second position in which the at least one sliding element is disengaged from the positioning element such that the positioning element is released and removable from the positioning member.

23. The positioning apparatus as claimed in claim 12, wherein the at least one sliding element comprises a pair of sliding elements.

24. The positioning apparatus as claimed in claim 23, further comprising a resilient member disposed between the pair of sliding elements.

25. The positioning apparatus as claimed in claim 24, wherein the resilient member is a coil spring.
